(19) United States
(12) Patent Application Publication
(10) Pub. No.: US 2019/0322301 A1
(43) Pub. Date: Oct. 24, 2019

(54) SYSTEMS AND METHODS FOR AN INTERLOCKING WAGON

(71) Applicant: TYLER HULL, Georgetown, TX (US)

(72) Inventor: TYLER HULL, Georgetown, TX (US)

(21) Appl. No.: 15/957,681

(22) Filed: Apr. 19, 2018

(51) Int. Cl. B62B 3/02; B62B 3/00

(52) U.S. Cl. CPC B62B 3/02; B62B 2501/04; B62B 2207/02; B62B 3/007

(57) ABSTRACT

Embodiments disclosed herein describe systems and methods for an interlocking wagon. In embodiments, the interlocking wagon may include a first component and a second component.

### BACKGROUND INFORMATION

### Field of the Disclosure

Examples of the present disclosure are related to systems and methods for an interlocking wagon. More particularly, embodiments relate to a wagon with a first component and a second component, wherein the first component and second component may be coupled and decoupled from one another.

### Background

Conventionally wagons are four wheeled vehicles that are propelled by human power via a handle. Typically, wagons include an open-top cuboid compartment for holding and transporting objects. These wagons include two sets of wheels, wherein one set of wheels is able to pivot in a manner that allows the wagon to be steered.

Additionally, some wagons are configured to be collapsible. Collapsible wagons typically include a hinge that allows the wagon to fold over itself. When a collapsible wagon is folded over itself, the length of the wagon is reduced. However, when folded, the height of the collapsible wagon increases, which results in the cubic volume occupied by the collapsible wagon to remain constant. This leads to difficulties when storing collapsible wagons in either the folded or unfolded state.

Furthermore, when a collapsible wagon is folded, the wagon is maintained in a unitary piece. Therefore, different components of conventional wagons may not be separated and used simultaneously.

Accordingly, needs exist for more effective and efficient systems and methods for a detachable wagon, wherein a first component of the wagon is configured to be separable from a second component of the wagon.

### SUMMARY

Embodiments disclosed herein describe systems and methods for an interlocking or detachable wagon. In embodiments, the interlocking wagon may include a first component and a second component. In embodiments, the first component and the second component may be separable and may be used simultaneously and independently of each other.

In a first mode of operation, the first component and the second component of the wagon may be configured to be interlocked together. When the first component and the second component of the wagon are interlocked, the wagon may form an integrated wagon. In embodiments, when the first component of the wagon and the second component of the wagon are interlocked, objects may be positioned within a compartment, wherein the compartment of the integrated wagon may defined by the sidewalls of the first component and the second component of the wagon. When the first component of the wagon and the second component of the wagon are interlocked, the wagon may be configured to transport the objects positioned within the compartment to various locations.

In a second mode of operation, the first component and the second component may be separated. This may allow the first component and the second component to form two slanted surfaces.

The first component and the second component may include first sidewalls, second sidewalls, first legs, and second legs.

The first sidewalls may be shorter than the second sidewalls, and the first sidewalls may be configured to couple the second sidewalls together. The first sidewalls may be positioned in a direction that is perpendicular to the second sidewalls. In embodiments, the second sidewalls may extend past the first sidewalls, such that the ends of the second sidewalls are not flush with the ends of the first sidewalls.

The first legs may be positioned on a first end of the first and second components, and the second legs may be positioned on a second end of the first and second components. The first legs may have a shorter height and a larger diameter than those of the second legs. In embodiments, the first legs may be configured to be positioned on an inner surface of the second legs and outer surface of the first legs on the first end of the first and second components. In embodiments, the second legs may be configured to be positioned on an inner surface of the second legs and outer surface of the first legs on the second end of the first and second components. To couple the first component and the second component, the second legs may be configured to be inserted into the first legs.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts an interlocking wagon, according to an embodiment.

FIGS. 2 and 3 depict a first component, according to an embodiment.

FIG. 4 depicts a detail view of a second leg, according to an embodiment.

FIG. 5 depicts a detail view of a first leg, according to an embodiment.

FIG. 6 depicts an interlocking wagon, according to an embodiment.

FIGS. 7-10 depict a first component of an integrated wagon, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Embodiments disclose an interlocking wagon. The interlocking wagon may be configured to hold and transport objects from a first location to a second location. Furthermore, the interlocking wagon may be configured to be disconnected into a first component and a second component. Responsive to disconnecting the first component of the wagon and the second component of the wagon, the components may be utilized individually for a game and/or stored individually.

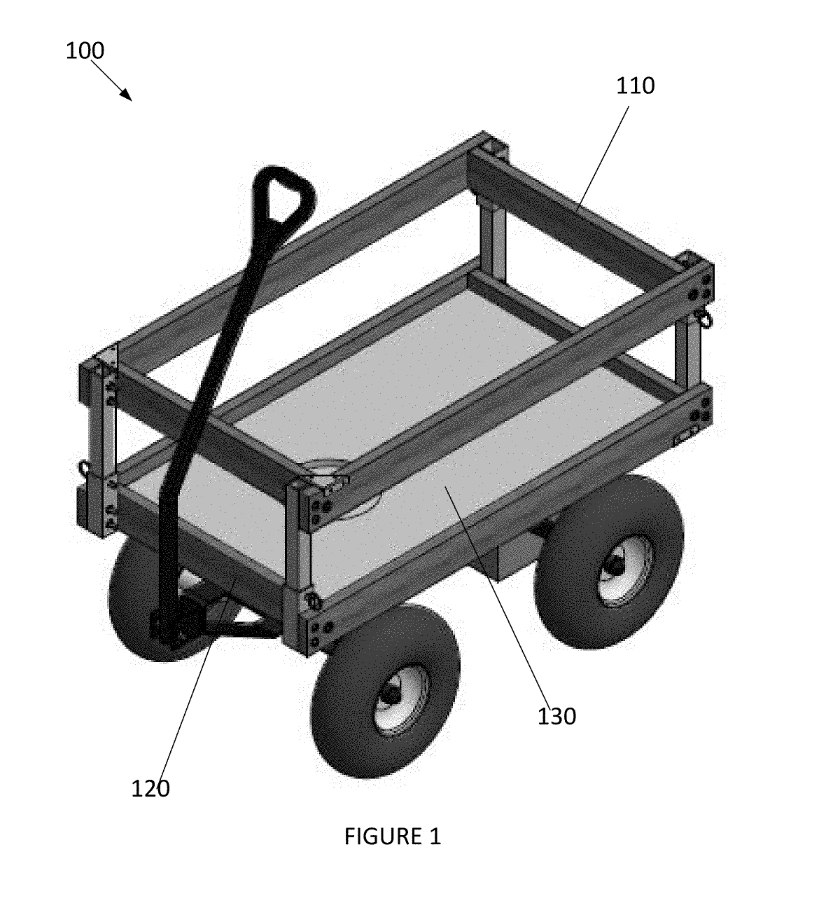

Turning now to FIG. 1, FIG. 1 depicts one embodiment of interlocking wagon 100. Interlocking wagon 100 may include first component 110 and second component 120. First component 110 and second component may be identical and interchangeable parts.

In a first mode of operation, first component 110 and the second component 120 of the interlocking wagon 120 may be configured to be coupled together. When first component 110 and second component 120 of the interlocking wagon 100 are coupled together, then the wagon may form an integrated wagon. As depicted in FIG. 1, in the first mode, base boards 130 may be positioned on a lower surface of wagon 100, wherein base boards 130 are used for a game.

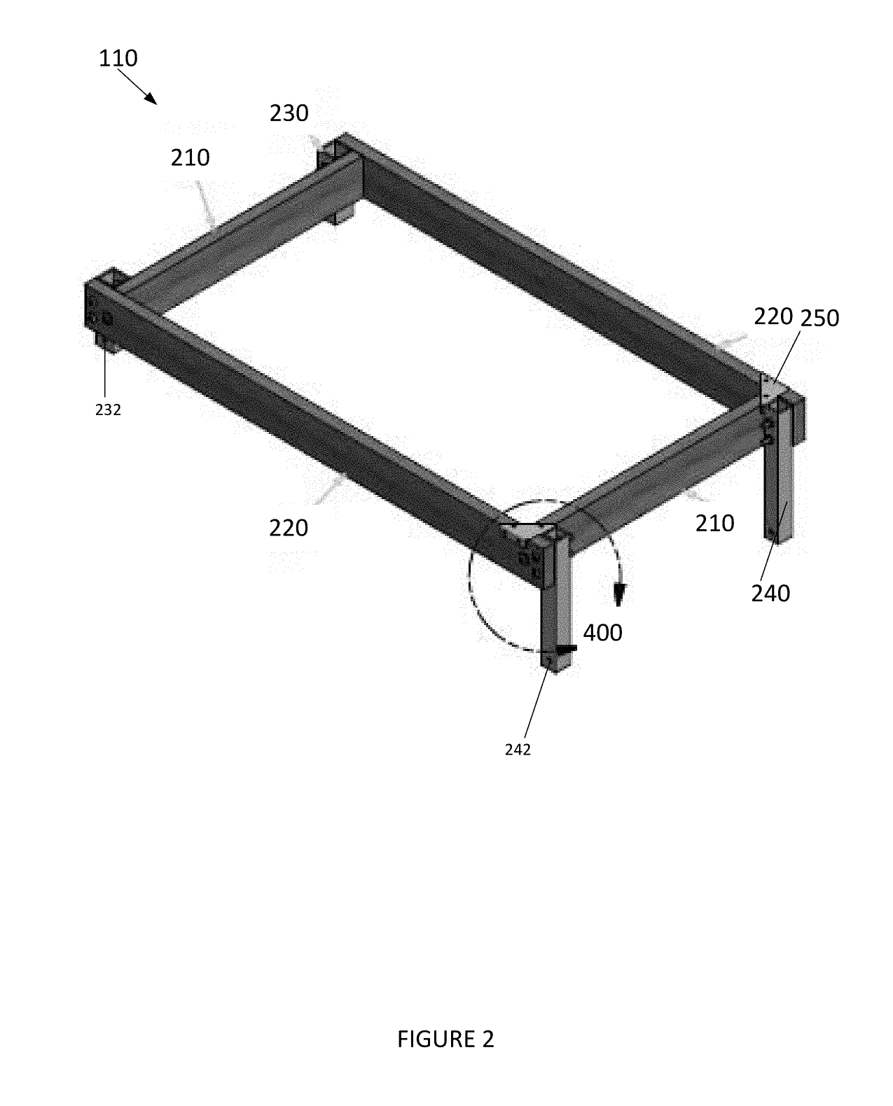

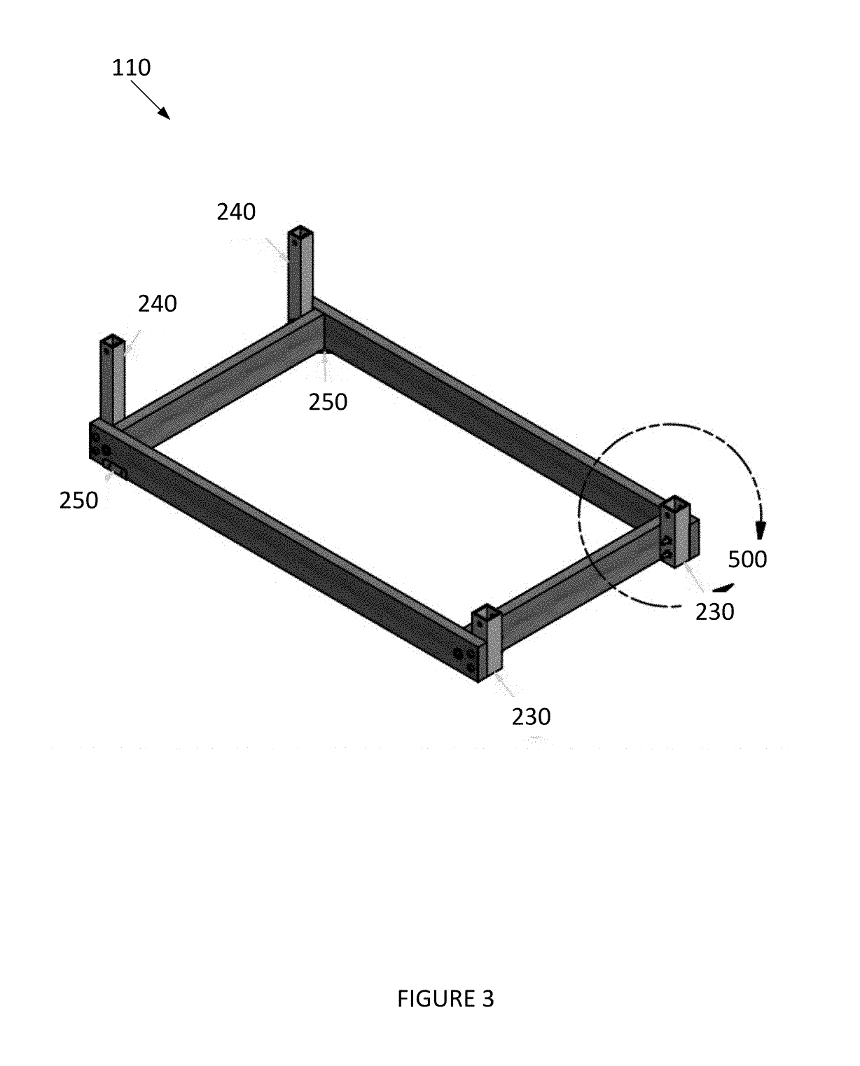

FIGS. 2 and 3 depicts first component 110, according to an embodiment. As discussed above, first component 110 and second component 120 may be identical pieces.

First sidewalls 210 may be positioned at both ends of first component 110. First sidewalls 210 may have a first length, which is shorter than a second length associated with second sidewalls 220. First sidewalls 210 may be configured to be coupled to the inner surfaces of second sidewalls 220.

Second sidewalls 220 may be configured to extend from the first end of first component 110 to the second end of first component 110. The first and second ends of second sidewalls 220 may be configured to extend past first sidewalls 210, such that the ends of second sidewalls 220 are not flush with the outer surface of first sidewalls 210.

First legs 230 may be configured to be positioned on the first end of first component 110. First legs 230 may have a hollow inner chamber having a first width and a first height. The first width may be greater than a second width associated with second legs 240, and the first height may be shorter than a second height associated with second legs 240. First legs 230 may be configured to be positioned adjacent to an inner surface of second sidewalls 220 and an outer surface of first sidewall 210. Such that the ends of first legs are flush against the ends of second sidewalls 220. First legs 230 may include first orifices 232 that are holes positioned through first legs 230. First orifices 232 may extend in a direction perpendicular to the longitudinal axis of first legs 230.

Second legs 240 may be positioned on the second end of first component 110. Second legs 240 may have a hollow inner chamber having the second width and the second height. Second legs 240 may be configured to be positioned adjacent to an inner surface of second sidewalls 220 and an outer surface of first sidewall 210. Such that the ends of second legs 240 are flush against the ends of second sidewalls 220. Second legs 240 0 may include second orifices 242 that are holes positioned through Second legs 240. Second orifices 242 may extend in a direction perpendicular to the longitudinal axis of second legs 240.

Coupling mechanisms 250 may be configured to couple first sidewalls 210 and second sidewalls 220. Coupling mechanisms 250 may be positioned at a second end of first component, and may be substantially triangular in shape. A first edge and first overhang of coupling mechanism 250 may be positioned over first sidewall 210, and a second edge and second overhang of coupling mechanism 25 may be positioned over second sidewall 220. As further depicted, a long edge of coupling mechanism 250 may be positioned within an area between first legs 230 and second legs 240.

In embodiments, second legs 240 of a first component 110 may be configured to be inserted into first legs 230 of a second component 120, and second legs 240 of the second component 120 may be configured to be inserted into the first legs 230 of a first component 110. This may couple the first component 110 and second component 120 together. Further, when second legs 240 are inserted into first legs 230, first orifices 232 may be aligned with second orifices 242. A bolt may be configured to be inserted through the orifices to secure first component 110 with second component 120. To decouple first component 110 and second component 120, the bolt may be removed, and the first component 110 and second component may slide apart.

When decoupled from each other, first component 110 and second component 120 may be placed on a flat surface. Due to first legs 230 and second legs 240 being different lengths, when positioned on the flat surface a plane of the upper surface of first component 110 and second component 120 may be angled.

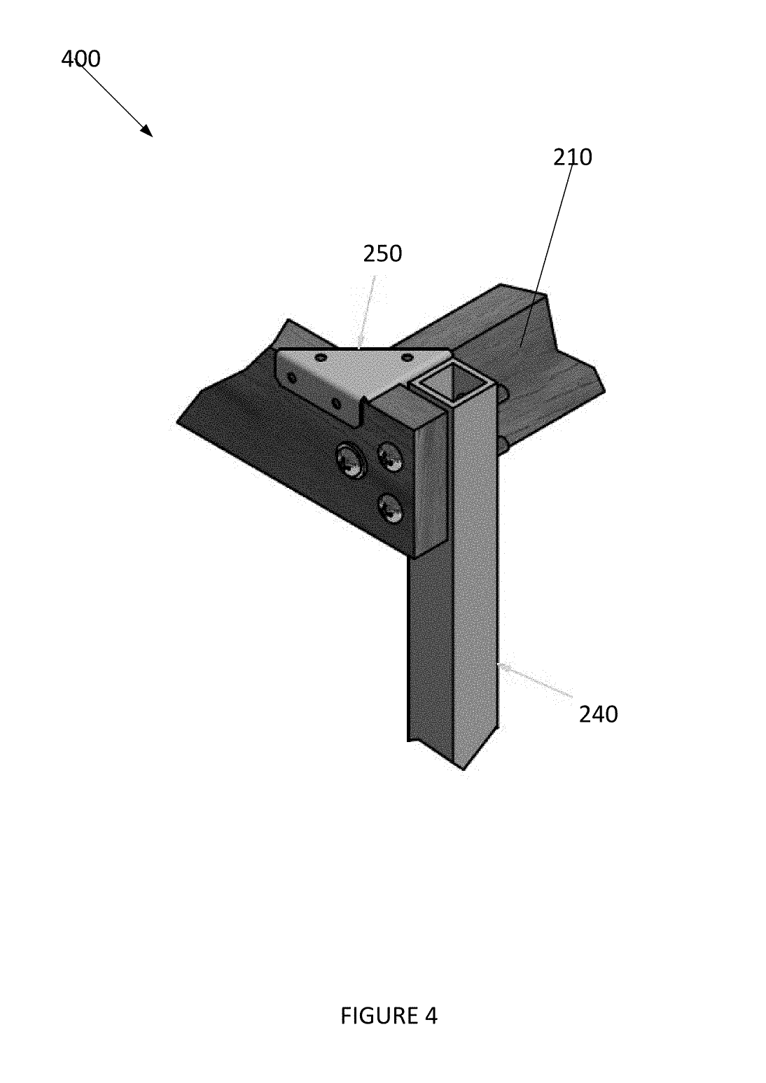

FIG. 4 depicts a detail view of second leg 240, according to an embodiment. Elements depicted in FIG. 4 may be described above, and for the sake of brevity another description of these elements is omitted. As depicted in FIG. 4, coupling mechanism 250 may be positioned between the edge of first sidewall 210 and second leg 240, which may allow coupling mechanism 250 to act as a spacer. The may cause the central axis of second leg 240 and the central axis of first leg 230 to be aligned, due to the larger width of first leg 230. As such, due to offsetting first second leg 240 from the outer surface of first sidewall 210, the central axis may be aligned.

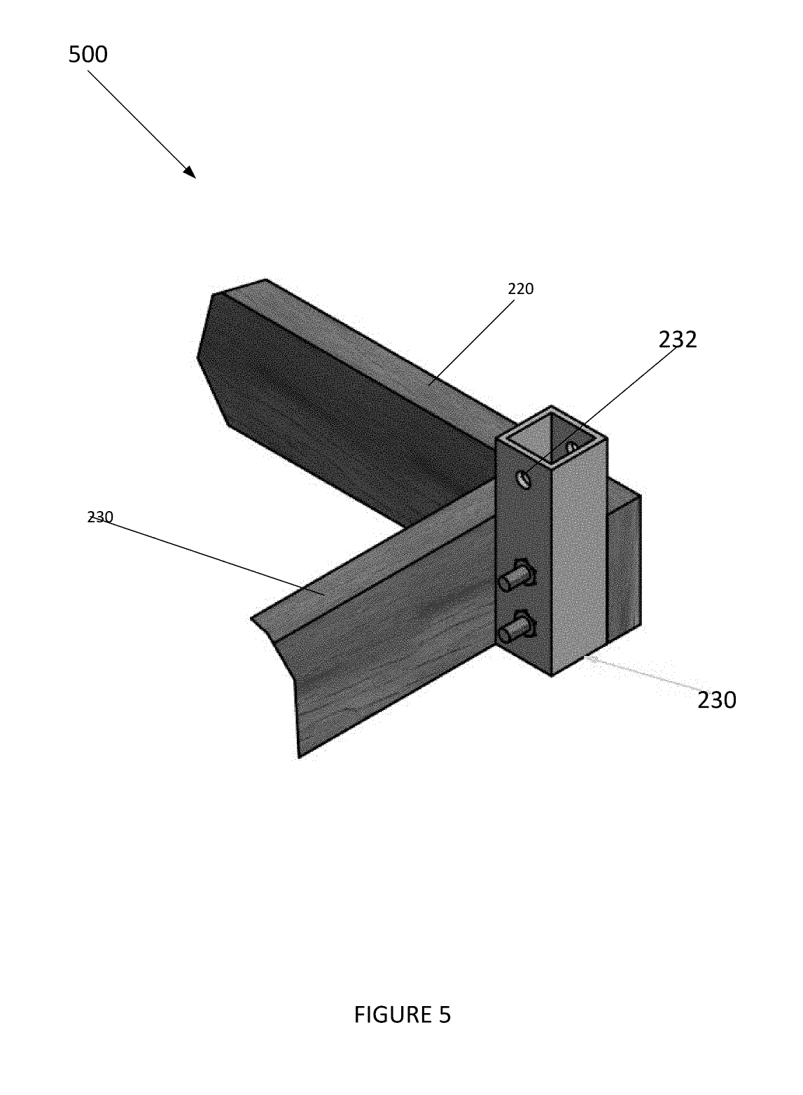

FIG. 5 depicts a detail view of first leg 230, according to an embodiment. Elements depicted in FIG. 5 may be described above, and for the sake of brevity another description of these elements is omitted.

As depicted in FIG. 5, first leg 230 may be positioned flush against the outer surface of both first sidewall 210 and second sidewall 220. As discussed above, this may allow for the alignment of first leg 230 and second leg 240.

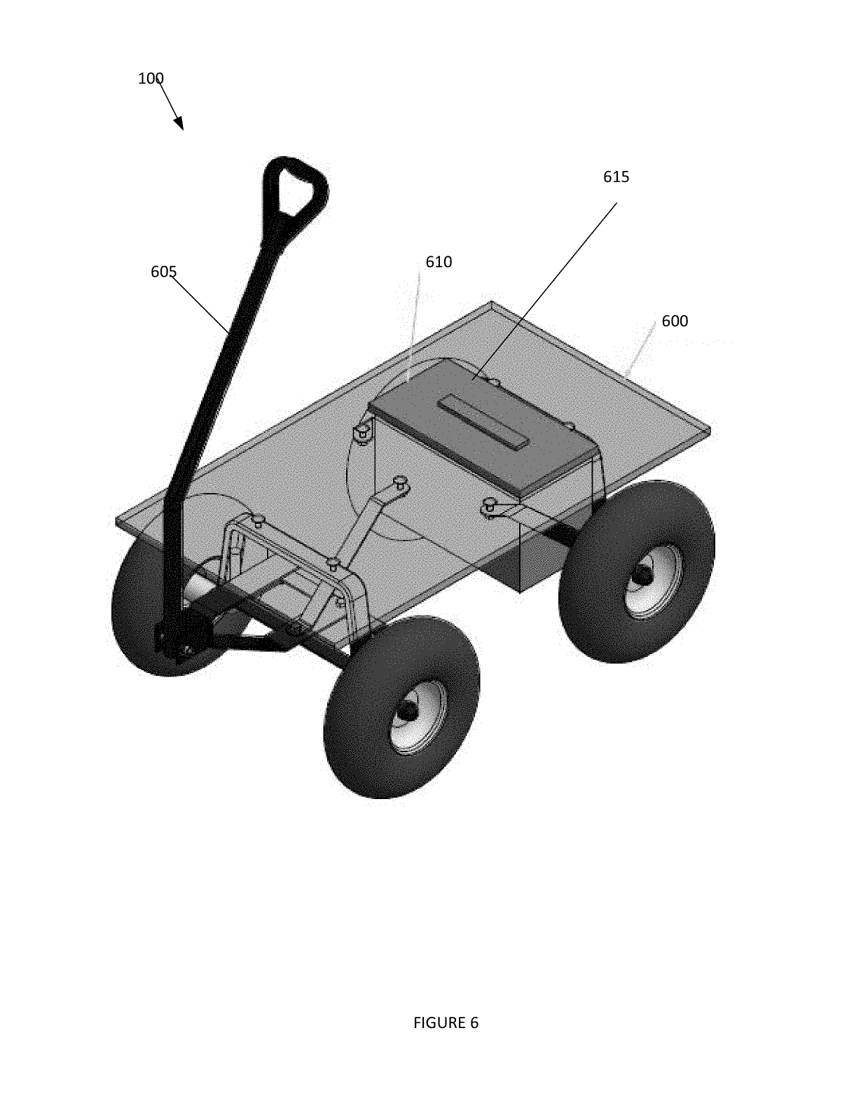

FIG. 6 depicts an interlocking wagon 100, according to an embodiment. Elements depicted in FIG. 6 may be described above, and for the sake of brevity another description of these elements is omitted.

As depicted in FIG. 6, interlocking wagon 100 may include a base 600 with a cutout 610. Base 600 may be configured to support first component 110 and second component 120 when positioned on base 600. Base 600 may have a length and width that corresponds with first component 110 and second component 120.

Base 600 may include a cutout 610, wherein an object 615 may be positioned within the cutout. For example, object 615 may be a case that can hold components of the gaming system.

Additionally, interlocking wagon 100 may include a handle 605 and a plurality of wheels.

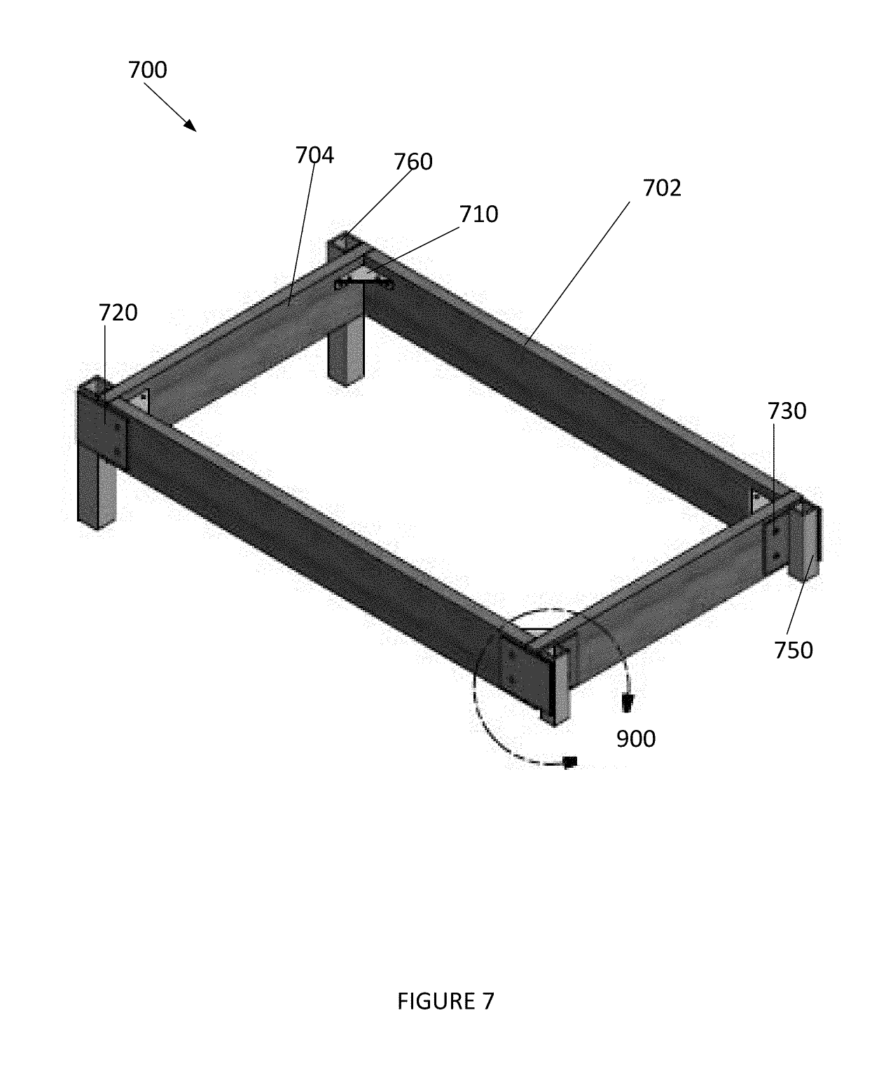

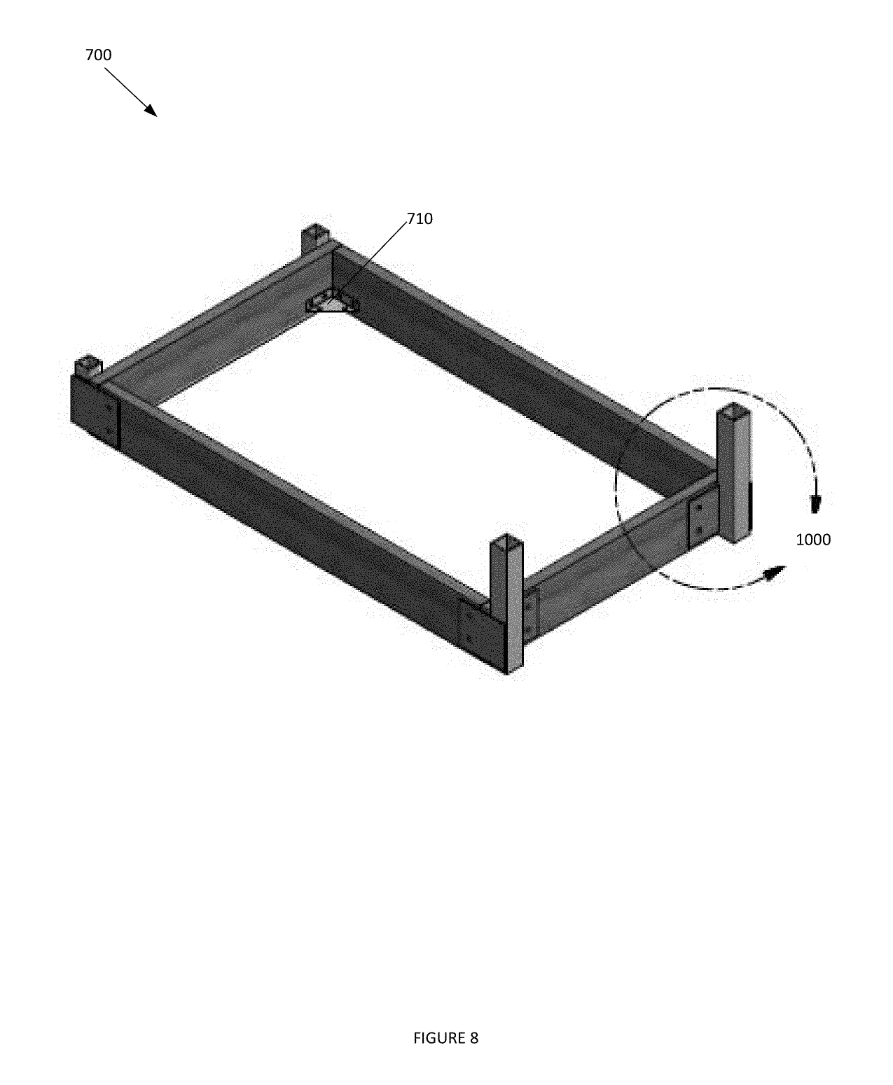

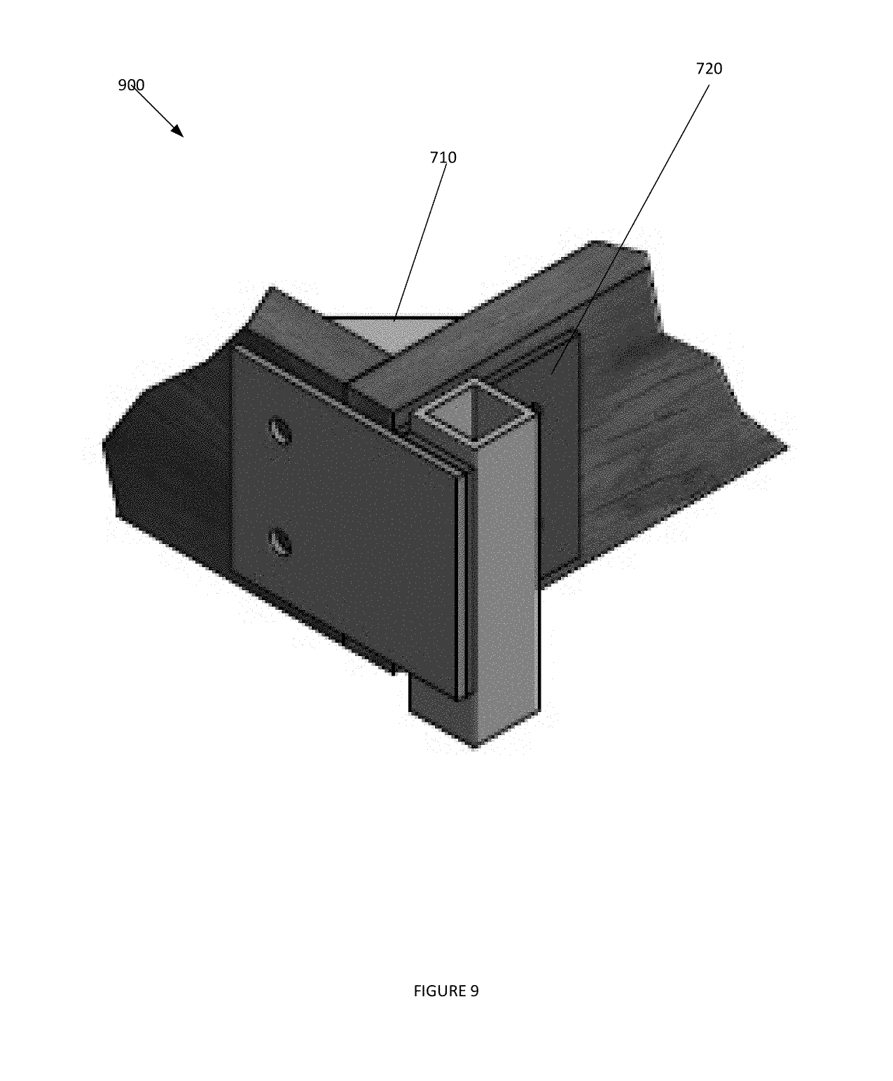

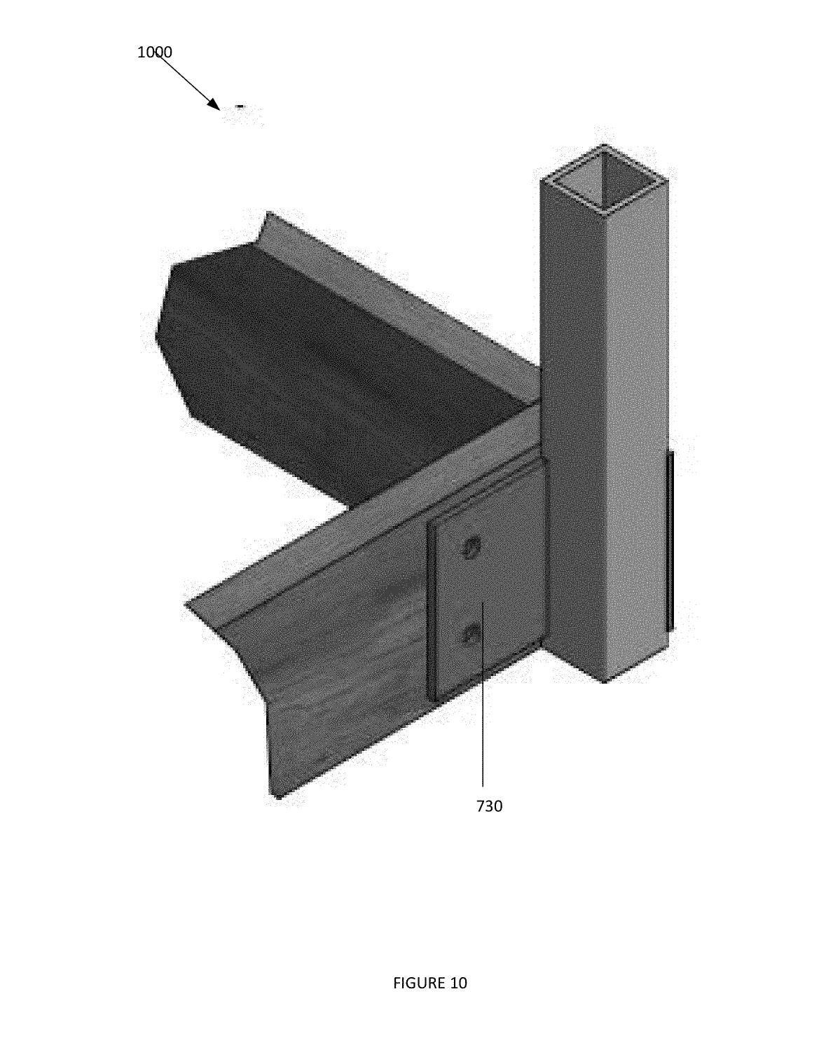

FIGS. 7-10 depict a first component 700 of an integrated wagon, according to an embodiment. Elements depicted in FIGS. 7-10 may be described above. For the sake of brevity, another description of these elements is omitted.

As depicted in FIGS. 7-10, first sidewalls 702 and second sidewalls 704 may have ends that are flush with each other. Panel holders 710 may be substantially rectangular shaped elements that are configured to be positioned at each internal intersection of first sidewalls 702 and second sidewalls 704. Panel holders 710 may be vertically offset from the upper surfaces of first sidewalls 702 and second sidewalls 704, such that a panel may be held in place on top of panel holders 710, and the upper surface of the panel is flush with the upper surfaces of first sidewalls 702 and second sidewalls 704.

Furthermore, first legs 750 and second legs 760 are configured to be positioned on outer surfaces of first sidewalls 704. In embodiments, second leg 760 may be configured to be coupled directly adjacent to first sidewall 704 via mounting bracket 720. Mounting bracket 720 may extend from the outer surface of second sidewall 702 to overlap with the outer surfaces of second legs 760.

First legs 750 may be configured to be coupled to the outer surface of first sidewalls 704 via spacer 730 and mounting bracket 720. Spacer 730 may be an “L-Shaped” object that is configured to be positioned between first legs 750 and first sidewall 704 and mounting bracket 720. This may shift the central axis of first legs 750 in both the longitudinal and lateral axis. The moving of the central axis of first legs 750 may enable second legs 760 to slide into first legs 750.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

What is claimed is:

1. An interlocking wagon comprising:
a first component with first sidewalls and second sidewalls, wherein a first end and a second end of the second sidewalls extend past the first sidewalls;
first legs positioned on a first distal end of the first component, the first legs being positioned on an inner surface of the second sidewalls and an outer surface of the first sidewalls, the first legs having a first width and a first height;
second legs positioned on a first proximal end of the first component, the second legs being positioned on the inner surface of the second sidewalls and the outer surface of the first sidewalls, the second legs having a second width and a second height.

2. The interlocking wagon of claim 1, further comprising:
a spacer positioned between the second legs and the outer surface of the first sidewalls.

3. The interlocking wagon of claim 2, wherein the second legs is positioned adjacent to the inner surface of the second sidewalls.

4. The interlocking wagon of claim 3, wherein the first legs are positioned adjacent to the inner surface of the second sidewalls and the outer surface of the first sidewalls.

5. The interlocking wagon of claim 1, wherein the first width is greater than the second width.

6. The interlocking wagon of claim 1, wherein the first height is shorter than the second height.

7. The interlocking wagon of claim 1, wherein the first legs include first orifices configured to receive a bolt, the first orifices extending in a direction perpendicular to a central axis of the first legs.

8. The interlocking wagon of claim 1, further comprising:
a second component being symmetrical to the first component.

9. The interlocking wagon of claim 8, wherein the first legs of the first component are configured to receive the second legs of the second component and the first legs of the second component are configured to receive the second legs of the first component.

10. The interlocking wagon of claim 1, further including:
panel mounts positioned at intersections of the first sidewalls and the second sidewalls, the panel mounts being vertically offset from the upper surfaces of the first sidewalls and the second sidewalls.
